(19) United States
(12) Patent Application Publication
(10) Pub. No.: US 2005/0265664 A1
(43) Pub. Date: Dec. 1, 2005

(54) Coupling structure between fiber and optical waveguide

(75) Inventors: Chien-Cheng Yang, Hsinchu (TW); Wen-Jiun Liu, Hsinchu (TW); Zhi-Cheng Hsiao, Hsinchu (TW)

Correspondence Address: Welsh & Katz, Ltd.;Eric D. Cohen, 22nd Floor, 12 South Riverside Plaza, Chicago, IL, 60606, US

(73) Assignee: Industrial Technology Research Institute, Hsinchu (TW)

(21) Appl. No.: 10/972,519

(22) Filed: Oct. 25, 2004

(30) Foreign Application Priority Data
Jun. 1, 2004 (TW) 93115644

(51) Int. Cl. G02B 6/30

(52) U.S. Cl. 385/49; 385/137

(57) ABSTRACT

A coupling structure between a fiber and an optical waveguide to couple the optical waveguide to the fiber is disclosed. A substrate includes an optical waveguide region and at least one aligning groove for containing the fiber. The optical waveguide region has optical circuits and input/output surfaces of the optical circuits. The input/output surfaces face the aligning groove. A non-perpendicular angle is formed between input/output surfaces and the progressing direction of the incident light.

### BACKGROUND OF THE INVENTION

1. Field of Invention

The invention relates to an optical coupling structure and, in particular, to a coupling structure between a fiber and an optical waveguide.

2. Related Art

Optical waveguides have many advantages such as highly stable, easy for mass production, easy to be integrated, highly sensitive, and unperturbed by electromagnetic waves. Therefore, they can be used in various kinds of environments. Planar lightwave circuits (PLC's) utilize semiconductor processes to make all kings of optical waveguide channels on a plane in order to provide functions of beam splitting, beam merging, and optical switches. Separated devices are integrated in this way on a complete platform to reduce whole module sizes, system complexity, and signal loss, and increase the reliability and yield of the devices.

The PLC uses a silicon chip as the substrate and has three layers of materials with different indices of refraction deposited thereon. The upper and lower layers are cladding layers. The middle layer is the waveguiding layer with a higher index of refraction. How to align and couple an optical waveguide to a fiber on the waveguide chip to transmit optical signals to other optical device and to reduce losses caused by the coupling is an important subject in the field of waveguide chip designs. The coupling between fibers and optical waveguides has been improved continuously. In the beginning, the fiber-waveguide coupling is between a single-channel waveguide and a single fiber. This is easier to be implemented. However, current optical waveguides have evolved toward high-density waveguide arrays. For example, the beam splitter in the optical waveguide is used to split the beam in a fiber to multiple fibers according to predetermined proportions of optical energy. It is also called a coupler. The one-to-many structure of the beam splitter has an input optical waveguide split into several receiving optical waveguides. Therefore, the single-channel waveguide to single fiber method is infeasible.

The coupling method currently used between the PLC and the fiber is to prepare a V-shape groove on an optical waveguide chip by etching. The V-shape groove fixes the fiber so that its kernel lies along a line in order to ensure the matching with the optical waveguide array. However, when a beam enters from the fiber surface to the receiving optical waveguide and from the optical waveguide to the fiber surface, the incident light is perpendicular to the cutting surfaces of them. This generates noisy reflective light from the cutting surfaces that enters the receiving optical waveguide, resulting in non-synchronous resonance. Therefore, optical loss occurs at the alignment coupling between the optical waveguide and the fiber. This affects the optical flux into and out of optical waveguides.

### SUMMARY OF THE INVENTION

In view of the foregoing, an objective of the invention is to provide a coupling structure between a fiber and an optical waveguide. By preparing an optical waveguide on a substrate and using an aligning groove, a good alignment can be achieved when the fiber is disposed in the groove to align with the optical waveguide, effectively reducing the coupling loss. The interface between the fiber and the optical waveguide has a non-perpendicular angle with the progressing direction of the light. This can avoid the reflection that occurs when the interface is perpendicular to the incident light and the noisy reflection at the cutting surfaces. This can effectively reduce or suppress noises during the transmission process.

The disclosed coupling structure couples the transmitting beam between a fiber and an optical waveguide. It is featured in that the substrate contains an optical waveguide region and a plurality of aligning grooves for containing the fibers. The optical waveguide region is provided with optical circuits and input/output (I/O) surfaces of the optical circuits. The I/O surfaces face the aligning grooves. The optical circuits aim at the positions for coupling with the optical fibers. The terminals of the optical circuits touch the I/O surfaces. A non-perpendicular angle is formed between the I/O surfaces and the progressing direction of the incident light.

Moreover, the cutting surfaces of the aligning grooves and the fibers can have a non-perpendicular angle with the progressing direction of the incident light and be parallel to the I/O surfaces in the optical waveguide region. The angle between the I/O surfaces and the progressing direction of the incident light has two preferred ranges. The angle is between 70 and 90 degrees if it is positive, whereas it is between −90 and −70 degrees if it is negative.

### BRIEF DESCRIPTION OF THE DRAWINGS

The invention will become more fully understood from the detailed description given hereinbelow illustration only, and thus are not limitative of the present invention, and wherein:

FIG. 1 is a schematic view of the first embodiment of the invention; and

FIG. 2 is a schematic view of the second embodiment of the invention.

### DETAILED DESCRIPTION OF THE INVENTION

The invention uses a beam splitter made of the optical waveguide as an embodiment. The optical path constructed from the beam splitters and the fibers along with its coupling structure is made on a substrate. It can be used in a fiber communication and other optical systems.

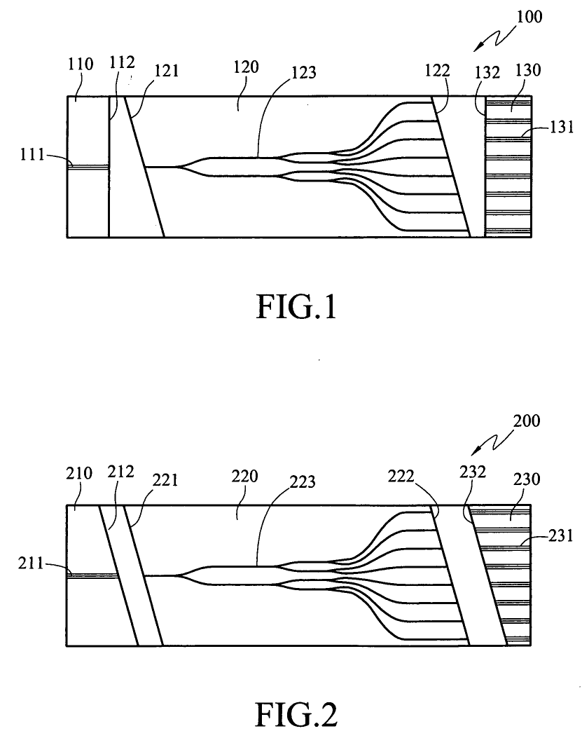

As shown in FIG. 1, the silicon substrate 100 is formed with an optical input region 110, an optical waveguide region 120, and an optical output region 130. The optical input region 110 has a first aligning groove 111 for containing an input fiber (not shown) to transmit incident light to the optical waveguide region 120. The optical input region 110 has an input surface 112. The cutting surfaces of the first aligning groove 111 and the input fiber touch the input surface 112. The optical output region 130 has several second aligning grooves 131 for containing several output fibers (not shown) to receive the several output beams from the optical waveguide region 120. The optical output region 130 includes a receiving surface 132. The cutting surfaces of the second aligning grooves 131 and the output fiber touch the receiving surface 132. The optical waveguide region 120 is a one-to-many beam splitter. The optical circuits 123 provided in the optical waveguide region 120 split the input light received by the optical input region 110 into several output beams to the optical output region 130. The optical waveguide region 120 has a first input/output (I/O) surface 121 and a second I/O surface 122. The first I/O surface 121 faces the input surface 112 of the optical input region 110. The second I/O surface 122 faces the receiving surface 132 of the optical output region 130. The optical circuits 123 are aligned to couple the fibers. Both ends of each optical circuit 123 touch the first I/O surface 121 and the second I/O surface 122. The first I/O surface 121 and the second I/O surface 122 have an angle of about 82 degrees with respect to the progressing direction of the incident light.

The I/O surfaces of the optical waveguide are not perpendicular to the progressing direction of the incident light but may have an arbitrary slant angle. Noisy reflections can thus be greatly reduced.

The input surface and the receiving surface may also have non-perpendicular angle with respect to the progressing direction of the incident light. Here the input surface and the receiving surface are parallel to the I/O surfaces. With reference to FIG. 2, the second embodiment of the invention forms an optical input region 210, an optical waveguide region 220 and an optical output region 230 on a silicon substrate 200. The optical input region 210 has a first aligning groove 211 for containing an input fiber (not shown) to transmit input light to the optical waveguide region 220. The optical input region 210 has an input surface 211. The surfaces of the first aligning groove 211 and the input fiber touch the input surface 212. The optical output region 230 has several second aligning grooves 231 for containing several output fibers to receive the several output beams from the optical waveguide region 220. The optical output region 230 has a receiving surface 232.

The cutting surfaces of the second aligning groove 231 and the output fiber touch the receiving surface 232. The optical waveguide region 220 is a one-to-many beam splitter. The several optical circuits 223 installed in the optical waveguide region 220 can split the incident light received by the optical input region 210 into several output beams to the optical output region 230. The optical waveguide region 220 has a first I/O surface 221 and a second I/O surface 222. Both ends of each optical circuit 223 touch the first I/O surface 221 and the second I/O surface 222. The first I/O surface 221 and the second I/O surface 222 have an angle about 82 degrees with respect to the progressing direction of the incident light. The input surface 212 of the optical input region 210 is parallel to the first I/O surface 221. The receiving surface 232 of the optical output region 230 is parallel to the second I/O surface 222. Each of the optical circuits 223 is aligned to couple to the corresponding fiber.

The input surface, the receiving surface, and the I/O surfaces of the disclosed coupling structure between a fiber and an optical waveguide can be formed using the semiconductor photolithography process with appropriate masks, followed by etching, or any other machining or body machining method. There are two preferred ranges of the angle between the I/O surfaces and the progressing direction of the incident light. The angle is between 70 and 90 degrees if it is positive, whereas it is between −90 and −70 degrees when it is negative. In the current embodiment, the angle is 82 degrees. Of course, it can be −82 degrees.

Certain variations would be apparent to those skilled in the art, which variations are considered within the spirit and scope of the claimed invention.

1. A coupling structure between a fiber and an optical waveguide comprising:
an optical waveguide region and a plurality of aligning grooves formed on a substrate, wherein the aligning grooves are provided for containing fibers to couple the fiber to a transmission beam in the optical waveguide region;
the optical waveguide region formed with an optical circuit and an input/output (I/O) surface, wherein the I/O surface faces the aligning groove, the terminal end of the optical circuit touches the I/O surface, and the optical circuit is aligned to couple to the position of the fiber; and
the I/O surface has a non-perpendicular angle with respect to the progressing direction of the incident light, and wherein a gap is formed between the fiber and the I/O surface.

2. The coupling structure between a fiber and an optical waveguide of claim 1, wherein the cutting surfaces of the aligning grooves and the fiber are parallel to the I/O surface.

3. The coupling structure between a fiber and an optical waveguide of claim 1, wherein the angle is between 70 and 90 degrees.

4. The coupling structure between a fiber and an optical waveguide of claim 3, wherein the angle is 82 degrees.

5. The coupling structure between a fiber and an optical waveguide of claim 1, wherein the angle is between −90 and −70 degrees.

6. The coupling structure between a fiber and an optical waveguide of claim 5, wherein the angle is −82 degrees.

7. The coupling structure between a fiber and an optical waveguide of claim 1, wherein the I/O surface is formed using a process selected from the group consisting of photolithography, surface machining and body machining.

8. A coupling structure between a fiber and an optical waveguide formed on a silicon substrate, the coupling structure comprising:
an optical input region, having a first aligning groove for containing an input fiber to transmit an input beam, wherein the optical input region has an input surface, and the cutting surfaces of the first aligning groove and the input fiber touch the input surface;
an optical output region, having a plurality of second aligning grooves for containing a plurality of fibers to receive a plurality of output beams, wherein the optical output region has a receiving surface, and the cutting surfaces of the second aligning groove and the output fiber touch the input surface; and
an optical waveguide region, having a plurality of optical circuits to split the input beam received from the optical input region into the output beams and to send them to the optical output region, said optical waveguide region having a first I/O surface and a second I/O surface;
wherein the both ends of each of the optical circuits touch the first I/O surface and the second I/O surface and each of the optical circuits is aligned to couple to the fiber, the first I/O surface and the second I/O surface having a non-perpendicular angle with respect to the progressing direction of the incident light, and wherein a gap is formed between the fibers and each I/O surface.

9. The coupling structure between a fiber and an optical waveguide of claim 8, wherein the input surface and the receiving surface are parallel to the I/O surfaces.

10. The coupling structure between a fiber and an optical waveguide of claim 8, wherein the angle is between 70 and 90 degrees.

11. The coupling structure between a fiber and an optical waveguide of claim 10, wherein the angle is 82 degrees.

12. The coupling structure between a fiber and an optical waveguide of claim 8, wherein the angle is between −90 and −70 degrees.

13. The coupling structure between a fiber and an optical waveguide of claim 12, wherein the angle is −82 degrees.

14. The coupling structure between a fiber and an optical waveguide of claim 8, wherein each I/O surface is formed using a process selected from the group consisting of photolithography, surface machining and body machining.
